(19) United States
(12) Patent Application Publication
(10) Pub. No.: US 2008/0166994 A1
(43) Pub. Date: Jul. 10, 2008

(54) Methods and apparatus to implement an internet multimedia sub-system (IMS) terminal

(76) Inventors: Bernard Ku, Austin, TX (US); Arshad Khan, Austin, TX (US); Niral Sheth, Austin, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/649,644

(22) Filed: Jan. 4, 2007

(51) Int. Cl. H04M 11/00

(52) U.S. Cl. 455/406

(57) ABSTRACT

Methods and apparatus to implement an Internet multimedia sub-system (IMS) terminal are disclosed. A disclosed example apparatus comprises a first interface configured to receive a user identification from a user, a second interface configured to receive billing information from the user, and a session manager to identify IMS service provider based on the received user identification, wherein a fee to access the IMS service provider is charged based upon the billing information. A disclosed example method comprises receiving a user identification from an IMS terminal, receiving billing information from the IMS terminal, determining an IMS service provider based upon the user identification, and billing a service charge for use of the IMS terminal based upon the billing information.

### FIELD OF THE DISCLOSURE

This disclosure relates generally to Internet multimedia sub-system (IMS) terminals and, more particularly, to methods and apparatus to implement an IMS terminal.

### BACKGROUND

Today, access to communication services (e.g., Internet multimedia sub-system (IMS) services) by a mobile and/or traveling user may require that a user carry a mobile device, such as a laptop that implements a softphone, a smartphone and/or a cellphone. However, the transportation of such devices can, in some instances, be burdensome due to weight and/or need for additional accessories such as chargers, power adapters, and/or cords. Moreover, such devices may not work in all locations to which a user may travel due to incompatibilities of implemented communication technologies.

### BRIEF DESCRIPTION OF THE DRAWINGS

FIG. 1 is a schematic illustration of an example voice Internet multimedia sub-system (IMS) communication system including an example IMS terminal constructed in accordance with the teachings of the invention.

FIG. 2A is a cutaway view of the example IMS terminal of FIG. 1 taken along line 2A-2A.

FIG. 2B is a cutaway view taken along line 2B-2B of FIG. 2A.

FIG. 3 is an illustration of another example IMS terminal that may be used in the example IMS communication system of FIG. 1.

FIG. 4 illustrates an example manner of implementing electronics for any of the example IMS terminals of FIGS. 1 and 3.

FIG. 5 illustrates an example data structure that may be used to store IMS communication service parameter, access network parameters and/or security parameters on a user transportable device.

FIG. 6 illustrates an example data structure that may be used to implement request an IMS service provider identifier.

FIGS. 7A and 7B illustrate an example manner of implementing the example session manager of FIG. 4.

FIG. 8 illustrates an example manner of implementing the example IMS service provider of FIG. 1.

FIG. 9 illustrates an example manner of implementing the example redirect server of FIG. 1.

FIGS. 10 and 11 are flowcharts representative of example processes that may be carried out to implement any of the example session managers of FIGS. 3 and 6 and, more generally, the example IMS terminals of FIGS. 1 and 3.

FIG. 12 is a flowchart representative of an example process that may be carried out to implement any of the example redirect servers of FIGS. 1, 9A and 9B.

FIG. 13 is a schematic illustration of an example processor platform that may be used and/or programmed to execute any or all of the example processes of FIGS. 10, 11, and 12 to implement any or all of the example session managers and/or the example redirect servers described herein.

### DETAILED DESCRIPTION

Methods and apparatus to implement an Internet multimedia sub-system (IMS) terminal are disclosed. A disclosed example apparatus includes a first interface configured to receive a user identification from a user, a second interface configured to receive billing information from the user, and a session manager to identify an IMS service provider based on the received user identification, wherein a fee to access the IMS service provider is charged based upon the billing information. Another disclosed example apparatus includes a housing, an externally accessible slot defined in the housing and dimensioned to receive a user transportable device, and a processor located in the housing to register the apparatus to an IMS network based on a parameter stored on the user transportable device. Yet another disclosed example includes a memory to store a plurality of IMS service provider identifiers for respective ones of a plurality of user identifiers, and a redirector to receive a message that contains a user identifier and billing information from an IMS terminal, to identify an IMS service provider identifier based upon the user identification, and to send the IMS service provider identifier to the IMS terminal.

A disclosed example method includes receiving a user identification from a user at an IMS terminal, receiving billing information from the user at the IMS terminal, providing the user identification and the billing information to a redirect server to obtain an Internet Protocol (IP) address for an IMS service provider, and registering the IMS terminal to the IMS service provider based upon the obtained IP address. Another disclosed example method includes receiving a user identification from an IMS terminal, receiving billing information from the IMS terminal, determining an IMS service provider based upon the user identification, and billing a service charge for use of the IMS terminal based upon the billing information. A disclosed example method of using an IMS terminal includes providing a user identification to the IMS terminal, providing billing information to the IMS terminal, and accessing an IMS service via the IMS terminal, the IMS service established based upon the provided user identification, and usage of the IMS terminal is billed based upon the provided billing information.

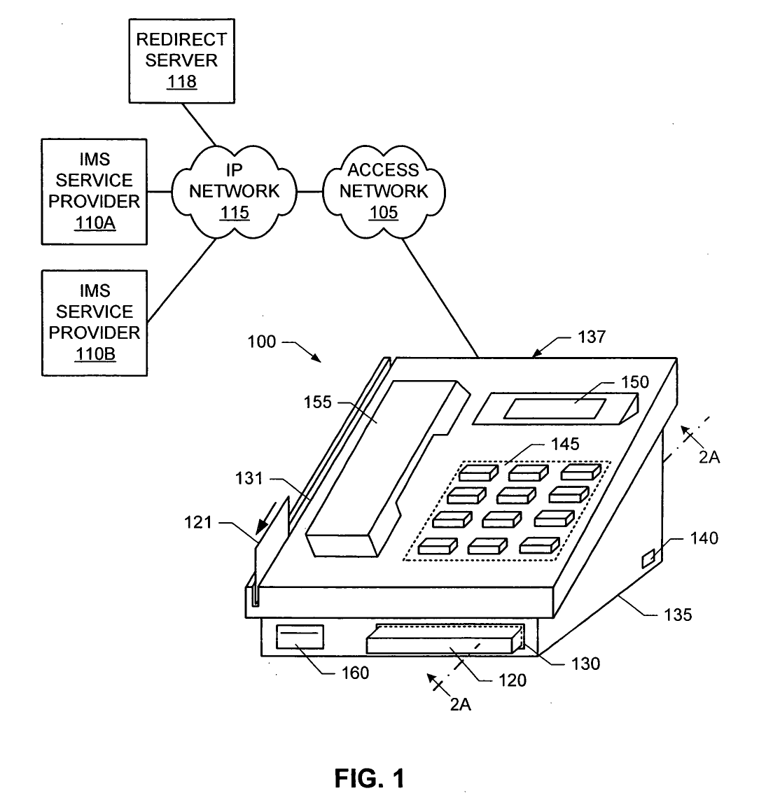

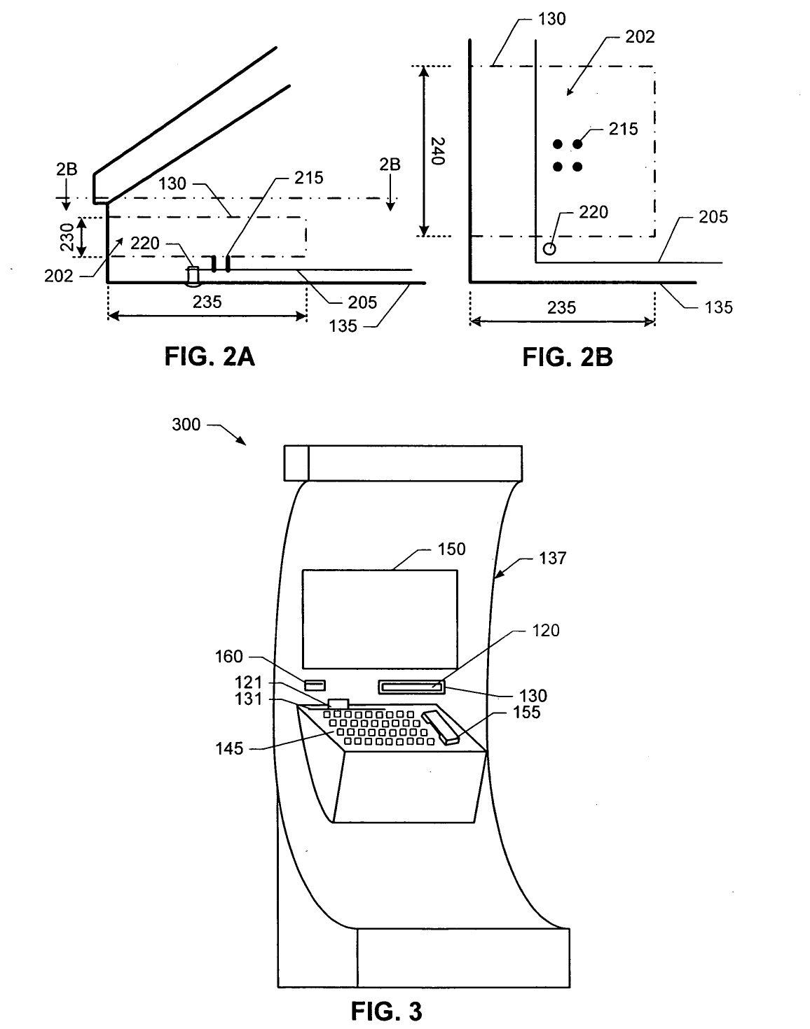

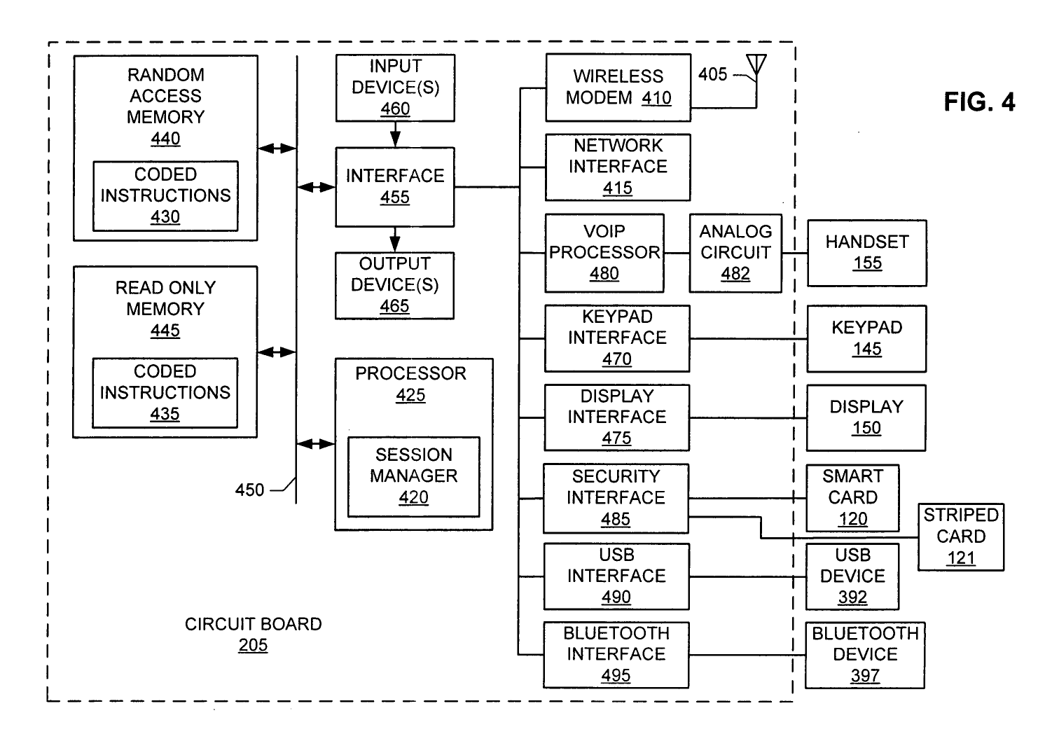

FIG. 1 is a schematic illustration of an example IMS based communication system that includes any number and/or type(s) of IMS terminals constructed in accordance with the teachings of the invention, one of which is illustrated with reference number 100 in FIG. 1. Example IMS terminals include, but are not limited to, a voice over Internet protocol (VoIP) phone 100, a personal digital assistant (PDA), a cellular phone (i.e., a cellphone), a smartphone, a laptop computer and/or a kiosk 300 (FIG. 3). The example kiosk 300 of FIG. 3 may be used in addition to and/or instead of the example phone 100 in the IMS communication system of FIG. 1. The example IMS terminals 100, 300 of FIGS. 1 and 3 may be implemented and/or found at any number and/or type(s) of locations. Example publicly accessible locations include, but are not limited to, a hotel lobby, an airport, a retail location, an office, a restaurant, a school, a medical facility, etc. The IMS terminals 100, 300 may also be located at private locations, such as an office building, a manufacturing location, a home, etc. Moreover, IMS terminals 100, 300 may be fixed location, substantially fixed location and/or mobile devices. For example, some IMS terminals 100, 300 can be rented (e.g., at an airport or car rental agency) for use while traveling. An example manner of implementing any of the example IMS terminals 100, 300 of FIGS. 1 and 3 is described below in connection with FIGS. 2A, 2B and 4.

In the interest of brevity and clarity, throughout the following disclosure references will be made to the example fault tolerant IMS communication system and/or the example IMS terminals 100, 300 of FIGS. 1 and 3. However, it should be understood that the methods and apparatus to implement the example IMS terminals 100, 300 described herein are applicable to other examples and/or types of IMS terminals, and/or IMS communication systems and/or networks.

To provide communication services (e.g., telephone services, Internet services, data services, messaging services, instant messaging services, electronic mail (email) services, chat services, video services, audio services, gaming services, etc.) over a site, location, building, geographic area and/or geographic region, the example IMS communication system of FIG. 1 includes any number and/or type(s) of access networks, one of which is illustrated in FIG. 1 with reference number 105. The example access network 105 of FIG. 1 can be implemented using any number and/or type(s) of past, present and/or future standards, specifications, communication devices, networks, technologies and/or systems, such as public switched telephone network (PSTN) systems, public land mobile network (PLMN) systems (e.g., cellular), wireless distribution systems, wired or cable distribution systems, coaxial cable distribution systems, Ultra High Frequency (UHF)/Very High Frequency (VHF) radio frequency systems, satellite or other extra-terrestrial systems, cellular distribution systems, power-line broadcast systems, fiber optic networks, and/or any combinations and/or hybrids of these devices, systems and/or networks.

In the example IMS communication system of FIG. 1, the example access network 105 is communicatively coupled to any number and/or type(s) of IMS service providers (two of which are illustrated in FIG. 1 with reference numerals 110A and 110B) via any number and/or type(s) of private and/or public Internet protocol (IP) based communication network 115 such as, for example, the Internet. In the illustrated example of FIG. 1, the example IMS terminal 100, 300 is communicatively coupled to the example access network 105 via any number and/or type(s) of past, current and/or future communication network(s), communication system(s), communication device(s), transmission path(s), protocol(s), technique(s), specification(s) and/or standard(s). For instance, the example IMS terminal 100, 300 may be coupled to the access network 105 via any type(s) of voice-band modem(s), digital subscriber line (DSL) modem(s), cable modem(s), Ethernet transceiver(s), optical transceiver(s), IP virtual private network (VPN) connection(s), Institute of Electrical and Electronics Engineers (IEEE) 802.11x (a.k.a. WiFi) transceiver(s), IEEE 802.16 (a.k.a. WiMax), wireless local area network (WLAN) access point(s), etc. Moreover, the example access network 105 and/or the example IP network 115 of FIG. 1 may extend geographically to include a location near to and/or encompassing one or more IMS terminals 100, 300. For example, the access network 105 may include a wireless access point (not shown) by which, for example, a WiFi IP phone 100 connects to the IP network 115.

In some examples, the IMS terminals 100, 300 may, at some instants in time, be able to communicate with the IP network 115 via more than one access network 105. For instance, the IMS terminals 100, 300 may implement more than one communication interface thereby allowing the IMS terminals 100, 300 to establish a communication session with more than one access network 105. For example, a mobile IMS terminal 100, 300 implements both a wireless local area network (WLAN) communication interface and a cellular (e.g., 3G) communication interface. Such an IMS terminal 100, 300 facilitates the access of IMS services provided by any or all of the IMS service providers 110A, 1110B over a broad geographic region. The implementation of multiple communication interfaces by an IMS terminal 100, 300 also facilitates the selection of an access network 105 based upon any number and/or type(s) of parameters, such as a user preference, a user input, cost of access, an ability of a user to be authenticated for particular access network 105, and/or desired data rate.

To identify an IMS service provider 110A, 110B for a particular user of the IMS terminal 100, 300, the example IMS communication system of FIG. 1 includes a redirect server 118. The example redirect server 118 of FIG. 1, receives a user identification from the IMS terminal, and based upon the received user identification determines which of the IMS service providers 110A, 110B provides the IMS services associated with the user identification. Example user identifications include, but are not limited to, a telephone number, an account number and/or an account name. The user identification may additionally include a password and/or personal identification number (PIN) that authenticates that an authorized subscriber is attempting to access IMS services associated with the user identification. An example manner of implementing the example redirect server 118 of FIG. 1 is described below in connection with FIG. 9.

In one example, the IMS terminal 100, 300 performs an electronic number (ENUM) query of the redirect server 118 based upon the user identification to obtain an IMS service provider identifier (e.g., an IP address) corresponding to the user identification. In another example, the IMS terminal 100, 300 sends to the redirect server 118 a SIP registration message that includes the user identification. The example redirect server 118 determines the IMS service provider identifier corresponding to the user identification, and returns the same to the IMS terminal 100, 300 via, for example, a SIP 3xx response message that includes the determined IMS service provider identifier. In the example IMS communication system of FIG. 1, the IMS terminal 100, 300 and the redirect server 118 communicate via an encrypted virtual private network (VPN) tunnel that facilitates the secure transfer of user identification data and/or billing information.

In the example IMS communication system of FIG. 1, the example access network 105, the IP network 115, the redirect server 118 and the IMS service providers 110A, 110B need not be owned, implemented, and/or operated by a single service provider. For example, the IMS terminal 100 may access IMS services provided by a first IMS service provider 110 via an access network 105 owned, operated and/or implemented by a second service provider. However, the access network 105, the IMS service provider 110A, 110B, the redirect server 118 and the IP network 115 may be operated by a single service provider.

In the example IMS communication system of FIG. 1, a user of the IMS terminal 100, 300 is billed a service charge for use of the IMS terminal 100, 300. Such a service charge is billed by the owner, leaser and/or operator of the IMS terminal 100, 300 and, in the illustrated example, is separate from and/or in addition to any charges, costs and/or fees associated with accessing and/or utilizing IMS services associated with a particular user identification. For example, the IMS terminal 100, 300 may be owned and/or made available by a first service provider who receives a service charge for use of the IMS terminal 100, 300, while an IMS service provider 110A, 110B has a separate service contract for IMS services associated with user identifications. For instances, a substantially fixed location IMS terminal 100, 300 could be located in an airport terminal such that the IMS terminal 100, 300 can be temporarily rented to access IMS services. In another example, a mobile IMS terminal 100, 300 could be rented (e.g., at a car rental agency) for use while traveling.

Such service charges for use of the IMS terminal 100, 300 may be based upon any number and/or type(s) of criteria. For example, service charges may be per minute, per use, per byte, based upon type of IMS service accessed, etc. To allow the service charges to be billed to the user of the IMS terminal 100, 300, the example IMS terminal 100, 300 collects billing information from the user and provides the billing information to the redirect server 118. Example billing information includes, but is not limited to, a credit card number, an account number, an account name, etc. The example redirect server 118 of FIG. 1 validates and/or processes the billing information before an IMS service provider identifier is provided to the IMS terminal 100, 300. As such, the billing information may additionally include a password and/or personal identification number (PIN) that the redirect server 118 uses to verify that the user is authorized to bill the service charges to the identified payment method. When the IMS terminal 100, 300 notifies the redirect server 118 that the current user of the IMS terminal 100, 300 has relinquished control of the IMS terminal 100, 300, the example redirect server 118 finalizes the IMS terminal usage service charges. Additionally or alternatively, the IMS terminal 100, 300 collects information pertaining to usage of the IMS terminal 100, 300. For example, the IMS terminal 100, 300 could collect call detail records (CDRs) that represent call made by the user via the IMS terminal 100, 300. Such collected usage information could be sent to the redirect server 118 and/or a billing server (e.g., the example billing agent 925 of FIG. 9 and/or any type of standalone billing server (not shown)). Such usage records allow the provider, owner and/or operator of the IMS terminal 100, 300 to bill for overall usage of the IMS terminal 100, 300 and/or based upon actual usage durations and/or call destinations. They may also be used for reconciliation of billing records between users and service providers. The example IMS terminal 100, 300 of FIG. 1 is pre-provisioned with, for example, the IP address of the billing server to which usage records are to be sent.

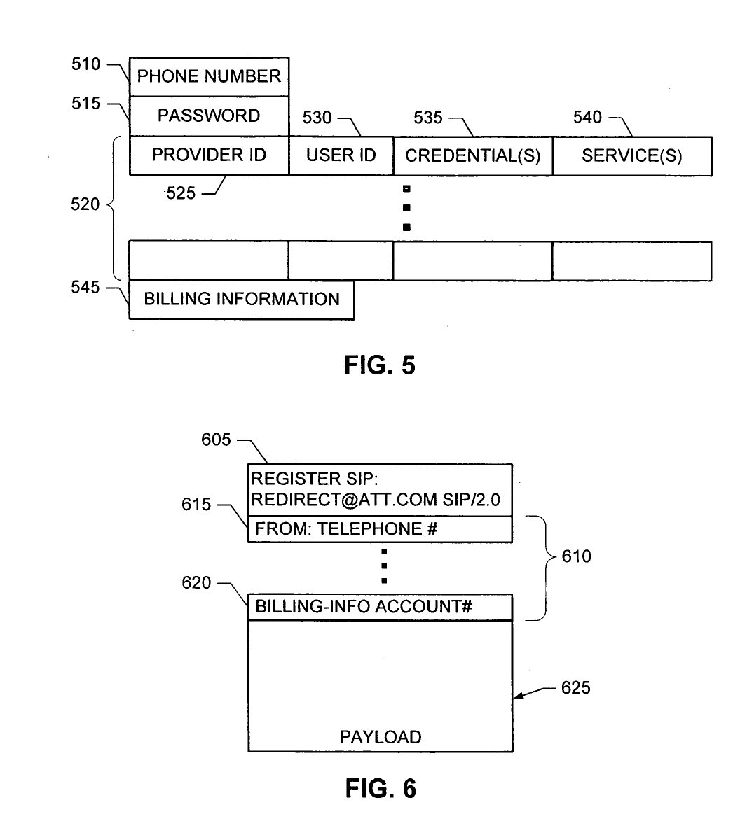

To obtain user identification and/or billing information pertaining to a user of the example IMS terminal 100, 300 of FIG. 1, the IMS terminal 100, 300 accepts and/or is able to communicate with any number and/or type(s) of user transportable device(s), two of which is illustrated in FIG. 1 with reference numerals 120 and 121. Example user transportable devices include, but are not limited to, a smartcard 120, a radio frequency identification (RFID) tag and/or a magnetically striped card 121 (e.g., a calling card, a credit card, etc.). In addition to user identification and/or billing information, the example user transportable devices 120, 121 may contain information and/or parameters for one or more IMS service providers 110A, 110B and/or one or more access networks 105 (i.e., security parameters). Such information may be used, possibly in conjunction with user inputs and/or selections, to select and/or establish a communication session with an access network 105 and/or an IMS service provider 110A, 110B. The example user transportable devices 120, 121 may include any type of security device and/or circuit that prevents access by unauthorized users. For example, the example IMS terminals 100, 300 could prompt the user to enter a username and password, and provide the entered username and password to the smartcard 120. If the username and password match those securely stored on the smartcard 120 (e.g., encrypted) is the IMS terminal 100, 300 is able to access IMS service parameters and/or security information stored on the smartcard 120. An example data structure that may be used to store user identification, billing information, IMS communication service parameters and/or access network parameters on a user transportable device 120, 121 is described below in connection with FIG. 5.

The user identification, billing information IMS communication service parameters and/or access network parameters may, additionally or alternatively, be provided by a user of the IMS terminal 100, 300 via one or more input devices and/or user interfaces provided by the IMS terminal 100, 300. For example, the IMS terminal 100, 300 could include a display 150 that prompts the user to enter such information via a keypad 145.

To allow the example user transportable device 120, 121 of FIG. 1 to be inserted into the example IMS terminals 100, 300, the IMS terminals 100, 300 include an externally accessible bay and/or slot 130. The example IMS terminals 100, 300 could, additionally or alternatively, include any type of magnetic stripe reader slot 131 that allows a user of the IMS terminal 100, 300 to, for example, swipe a magnetically striped user transportable device 120, 121. In some example IMS terminals 100, 300, the IMS terminal 100, 300 can access a nearby user transportable device 120, 121 (e.g., an RFID tag) without the device 120, 121 having to be swiped and/or inserted into the IMS terminal 100, 300. Persons of ordinary skill in the art will readily recognize that any combination of methods may be used to provide user identification, billing information IMS communication service parameters and/or access network parameters. For example, user identification could be obtained from a smartcard 120, billing information obtained by swiping a credit card 121, and IMS communication service parameters and/or access network provides obtained via the keypad 145.

The example slot 130 of FIG. 1 is defined in a base 135 of a housing 137 of the example IMS terminal 100. The example bay and/or slot 130 of FIGS. 1 and 3 is dimensioned to receive the example user transportable device 120, 121. The example user transportable device 120, 121 of FIGS. 1 and 3 has a form factor in accordance with a past, present and/or future contact smartcard standard, such as the International Organization for Standardization (ISO)/International Electrotechnical Commission (IEC) 7810 and 7816 standards. Alternatively, the example user transportable device 120, 121 can have a form factor in accordance with a past, present and/or future contactless smartcard standard, such as the ISO/IEC 14443 standard for contactless smartcards. Such devices are commonly referred to in the industry as smartcards and are purposefully designed to be user-transportable, user-insertable and to securely store and/or contain user information.

To provide electrical power for the example IMS terminal 100 of FIG. 1, the IMS terminal 100 includes any type of power connector 140. Depending upon the implementation of the example IMS terminal 100, the example power connector 140 of FIG. 1 may connect the example IMS terminal 100 to any type(s) of alternating current (AC) or direct current (DC) power sources. The example power connector 140 is structured to connect the example IMS terminal 100 to an AC-to-DC power conversion adapter. Additionally or alternatively, the IMS terminal 100 may be capable to operate using power from a battery such that the power connector 140 may be used to either charge the battery and/or power the IMS terminal 100.

To allow a person to, among other things, dial a telephone number, provide user identification and/or provide billing information, the example IMS terminal 100 of FIG. 1 includes any type of keypad 145 containing any number and/or type(s) of keys. An example keypad 145 includes four (4) rows with three (3) keys per row. The example keypad 145 of FIG. 1 may include any variety and/or number of additional keys to control advanced features of the example IMS terminal 100 such as, for example, speed dialing, access to voicemail, internet browsing, control of playback of audio and/or video, terminate and/or relinquish usage of the IMS terminal 100, initiate usage of the IMS terminal 100, etc.

To allow a person to view information (e.g., a prompt, the telephone number of an incoming telephone call, a webpage, a video, etc.), the example IMS terminal 100 of FIG. 1 includes any type of display 150. An example display 150 is a liquid crystal display (LCD) capable of displaying, among other things, alphanumeric characters.

To allow a person to participate in a telephone call, the example IMS terminal 100 of FIG. 1 includes any type of handset 155. The example handset 155 of FIG. 1 includes any type of speaker and any type of microphone, and is connected to the example base 135 of the example IMS terminal 100 via any type of communication cable (e.g., a conventional coiled telephone cable). Additionally or alternatively, any type of cordless handset may be communicatively coupled to the example base 135 via any type of cordless communication techniques and/or signals such as, for example, 900 Mhz, 2.4 Ghz, and/or 5.8 Ghz cordless handsets. That is, the example IMS terminal 100 of FIG. 1 may connect with any combination of corded and/or cordless handsets. For instance, an example VoIP phone may include both a corded handset and a cordless handset. Additionally, the example IMS terminal 100 of FIG. 1 may implement any number of VoIP telephone lines. Moreover, the example IMS terminal 100 of FIG. 1 may implement, in addition to any number of VoIP phone lines, any number of PSTN based phone lines.

It will be readily apparent to persons of ordinary skill in the art that the example IMS terminal 100 of FIG. 1 can alternatively be adapted to implement a VoIP analog terminal adapter. For example, the example keypad 145, the example display 150 and the example handset 155 could be implemented by any type of conventional PSTN-based telephone. Further, the example base 135 could include any type of circuit such as, for example, a subscriber line interface circuit (SLIC) to allow the conventional PSTN-based phone to be communicatively coupled to the IMS terminal 100.

To allow a person to connect a portable device (e.g., a printer, a scanner, a laptop, a personal digital assistant (PDA), a smart phone, a cellphone, etc.) to the IMS terminals 100, 300, the example IMS terminals 100, 300 include any number and/or type(s) of computer interfaces such as, for example, a universal serial bus (USB) interface 160 and/or a bluetooth interface. An example manner of implementing a portion of the electronics for the example IMS terminals 100, 300 of FIGS. 1 and 3 is discussed below in connection with FIG. 4.

While an example IMS terminal 100 that serves principally as a VoIP phone is illustrated in FIG. 1, persons of ordinary skill in the art will readily appreciate that the methods and apparatus disclosed herein may be applied to implement any number and/or type(s) of IMS terminals that implement an interface for a user transportable device 120, 121. Further, while a particular phone housing 137 having a particular form factor is illustrated in FIG. 1, VoIP phones (i.e., IMS terminal) that accept a user transportable device 120, 121 may be implemented in any type, size and/or shape of housing. For example, the housing 137 could be readily adapted to implement any type of housing(s) suitable for other types of VoIP phones (e.g., a smartphone). Further still, an IMS terminal may a have a different form factor than that illustrated in FIGS. 1 and/or 3. Moreover, while the example IMS terminal 100 of FIG. 1 is principally designed to implement VoIP functionality (i.e., a dedicated VoIP phone), persons of ordinary skill in the art will readily appreciate that the IMS terminal 100 may additionally include and/or implement non-VoIP functionality such as, for example, a clock, a web browser, a videophone, etc.

FIGS. 2A and 2B are cross sectional views of portions of the example IMS terminal 100 of FIG. 1. FIG. 2A is a side cutaway view of a portion of the example base 135 taken along line 2A-2A of FIG. 1. FIG. 2B is a top cutaway view of a portion of the example base 135 taken along line 2B-2B of FIG. 2A. For ease of understanding, like elements in FIGS. 1, 2A and 2B have been numbered with like reference numerals in FIGS. 1, 2A and 2B.

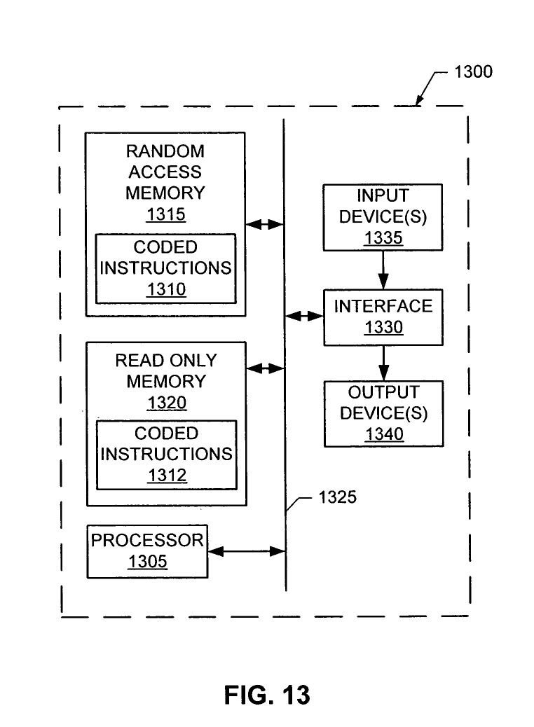

The example bay and/or slot 130 of FIGS. 1, 2A and 2B define a space 202 in which a contact smartcard 120 (i.e., a user transportable device) may be inserted. To allow electronics and/or devices of an inserted user transportable device 120 to communicate with electronics and/or devices of a circuit board 205 (e.g., the example processor 225 discussed below in connection with FIG. 4 and/or the example processor 1305 discussed below in connection with FIG. 13), the example circuit board 205 of FIGS. 2A-B includes any type of electrically conductive contacts and/or pads 215. The example contacts and/or pads 215 of FIG. 2 are arranged and/or positioned so as to align with gold contact pads of an inserted contact smartcard 120. When the smartcard 120 is fully inserted, the example contacts 215 provide an electrically conductive path between the electronics of the inserted smartcard 120 and the devices of the example circuit board 205

To mount and/or otherwise hold the example circuit board 205 of FIGS. 2A-B in place inside the example phone housing 137 and/or in correct alignment with the example bay 130, the example circuit board 205 is attached to the example base 135 using any variety and/or number of mechanical and/or chemical fasteners 220 such as, for example, a bolt, a screw, a grommet, a rivet, glue, etc.

While not shown, the example bay 130 of FIGS. 1, 2A and 3B may include any number and/or variety of groves, ridges, guides, etc. suitable to assist in the insertion of a smartcard 120. The example bay 130 of FIGS. 1 and 2A-B is dimensioned to correspond to the dimensions of a smartcard 120. In particular, a height 230 of the space 202 illustrated in FIG. 2A corresponds substantially to the nominal thickness of a smartcard 120. A depth 235 of the example space 202 illustrated in FIGS. 2A and 2B correspond to the nominal length of a smartcard 120 minus an amount by which an inserted smartcard 120 is to intentionally protrude from the example phone housing 135. The protrusion of an inserted smartcard 120 from the example phone housing 135 allows a person to firmly grasp and remove the user transportable device 120. A width 240 of the example space 202 illustrated in FIG. 2B corresponds to the nominal width of a smartcard 129. Alternatively, a smartcard 120 does not protrude from the phone housing 137 when inserted and the phone housing 137 includes some means to eject an inserted smartcard 120. Further still, the phone housing 137 could include a door and/or cover to conceal and/or obscure an inserted smartcard 120.

While the example bay 130 illustrated in FIGS. 2A and 2B is for a contact smartcard 120, persons of ordinary skill in the art will readily appreciate that the bay 130 could, additionally or alternatively, support a contactless smartcard and/or a magnetic striped card. For example, the example contacts and/or pads 215 could be replaced with any type of RFID reader device configured to communicate with a contactless smartcard, and/or the contacts and/or pads 215 could be replaced with a magnetic stripe reader configured to read the information encoded into the magnetic stripe of an inserted magnetically striped card.

FIG. 3 illustrates another example IMS terminal 300 having a form factor of a kiosk. Because elements of the example kiosk 300 of FIG. 3 are identical to those discussed above in connection with FIGS. 1, 2A and 2B, the descriptions of those elements are not repeated here. Instead, identical elements are illustrated with identical reference numerals in FIGS. 1, 2A, 2B and 3, and the interested reader is referred back to the descriptions presented above in connection with FIGS. 1, 2A and 2B for a complete description of those like numbered elements.

Persons of ordinary skill in the art will readily recognize that the example bay and/or slots 130, 131 of FIG. 3 can be constructed, dimensioned and/or implemented similarly to the example bay and/or slots 130, 131 of FIGS. 2A and 2B. That is the example slot 130 of FIG. 3 can be used to insert a user transportable device 120, 121 (e.g., a smart card and/or magnetic striped card). However, because the form factor of the example housing 137 of FIG. 3 is different from that described in connection with FIG. 1, the locations of the bay and/or slots 130, 131 may be different for the example IMS terminal 300. In particular, while the example bay and/or slots 130, 131 of FIG. 1 are located in the example base 135 of FIG. 1, the example bay and/or slots 130, 131 of FIG. 3 are located below the display 150 implemented by the example kiosk 300.

FIG. 4 illustrates an example manner of implementing electronics for any of the example IMS terminals 100, 300 of FIGS. 1 and 3, that is, the example circuit board 205 of FIGS. 2A and 2B. To implement wireless communications with, for example a WLAN and/or PLMN, the example circuit board 205 of FIG. 4 includes any number and/or type(s) of radio frequency (RF) antennas 405 and any number and/or type(s) of wireless modems 410. The example RF antenna 405 and the example wireless modem 410 of FIG. 4 are able to receive, demodulate and decode cellular (e.g., 3G), WLAN, WiFi and/or WiMax signals transmitted by and/or within a WLAN and/or PLMN. Likewise, the wireless modem 410 and the RF antenna 405 are able to encode, modulate and transmit cellular (e.g., 3G), WLAN, WiFi and/or WiMax signals to and/or within a WLAN and/or PLMN. Thus, as commonly referred to in the industry, the example RF antenna 405 and the example wireless modem 410 collectively implement the physical layer (a.k.a. PHY) for the example circuit board 205 of FIG. 4. However, a circuit board 205 need not include a wireless PHY.

To communicatively couple the example circuit board 205 of FIG. 4 to another device and/or network (e.g., a local area network (LAN), a modem, a router, a bridge and/or a gateway), the example circuit board 205 of FIG. 4 includes any number and/or type(s) of network interfaces 415. However, a circuit board 205 need not include a network interface 415. The example network interface 415 of FIG. 4 operates in accordance with any of the IEEE 802.3x (a.k.a. Ethernet) family of standards. The example circuit board 205 of FIG. 4 may also include any other type of communication interface(s), such as any type of voice-band modem(s), DSL modem(s), cable modem(s), Ethernet transceiver(s), optical transceiver(s), IP VPN connection(s), IEEE 802.11x (a.k.a. WiFi) transceiver(s), IEEE 802.16 (a.k.a. WiMax) transceiver(s), etc.

The example PHY (e.g., the example wireless modem 410 and the example antenna 405) and/or the example network interface 415 of FIG. 4 can be used to communicatively couple the circuit board 205 and/or, more generally, an IMS terminal 100, 300 to any or all of the IMS network service providers 110A, 110B via the access network 105 (FIG. 1). Which of the PHY and/or the network interface 415 are used to connect to a particular access network 105 depends upon the type(s) of access networks 105 available to the IMS terminal 100, 300 and/or depends upon the selection of a specific access network 105 and/or a specific operator of access networks 105. For example, a user that inserts a user transportable device 120 into an IMS terminal 100, 300 may have one or more parameters stored on the identification device 120 that identifies one or more preferred access networks 105 and/or operators of access networks 105. Any or all of the session manager 420, the processor 425, the network interface 415 and/or the PHY implement an encrypted VPN tunnel to facilitate secure transmission of user identification data and billing information to the redirect server 118.

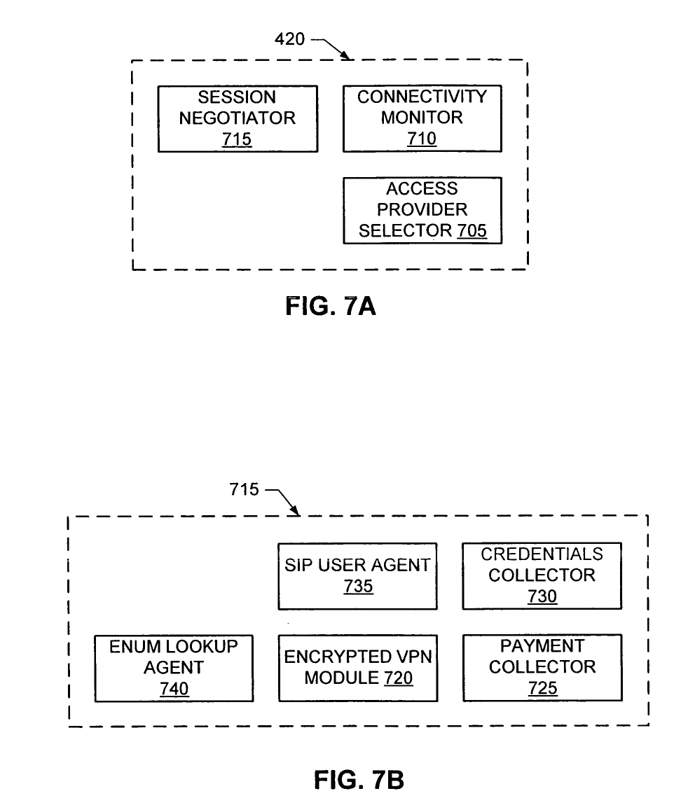

To manage communication and/or communication sessions with access networks 105 and/or IMS service providers 110, the example circuit board 205 of FIG. 4 includes a session manager 420. The example session manager 420 of FIG. 4 selects an access network 105 and/or receives one or more user inputs that select an access network 105, and uses the selected access network 105 to establish one or more IMS communication sessions with one or more of the IMS service providers 110A, 110B. In some examples, the session manager 420 selects an IMS service provider 110A, 110B and/or receives one or more user inputs that select an IMS service provider 110A, 110B. The selection of an access network 105 and/or an IMS service provider 110A, 110B may be based upon one or more parameters obtained from an inserted user transportable device 120, 121. Additionally or alternatively, the selection(s) may be based upon which access network 105 and/or IMS service providers 110A, 110B are available, and/or based upon a particular IMS service to be accessed. An example manner of implementing the example session manager 420 of FIG. 4 is described below in connection with FIGS. 7A and 7B.

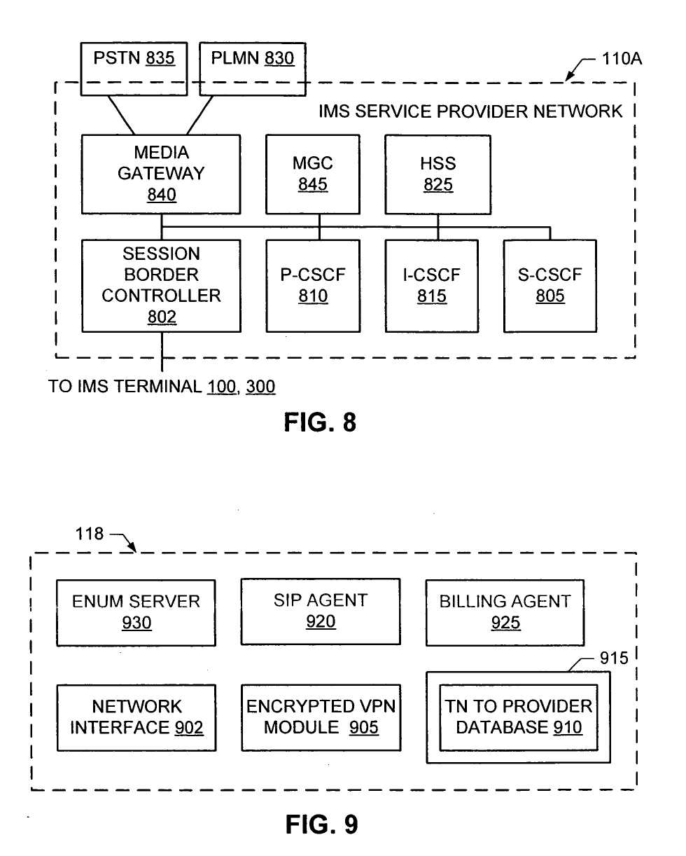

To implement the example session manager 420 using one or more of any number and/or type(s) of software, firmware, processing thread(s) and/or subroutine(s), the example circuit board 205 of FIG. 4 includes a processor 425. The example processor 425 of FIG. 4 may be and/or include one or more of any type(s) of processors such as, for example, a microprocessor, a processor core, a microcontroller, a digital signal processor (DSP), an advanced reduced instruction set computing (RISC) machine (ARM) processor, etc. The example processor 425 executes coded instructions 430 and/or 435 which may be present in a main memory of FIG. 4 (e.g., within a random-access memory (RAM) 440 and/or a read-only memory (ROM) 445) and/or within an on-board memory of the processor 425. The example processor 425 may carry out, among other things, the example process illustrated in FIG. 8 to implement the example session manager 420.

While in the illustrated example of FIG. 4, the example session manager 420 is implemented by executing one or more type(s) of software, firmware, processing thread(s) and/or subroutine(s) with the example processor 425, the example session manager 420 of FIG. 4 may be, additionally or alternatively, implemented using any number and/or type(s) of application specific integrated circuit(s) (ASIC(s)), programmable logic device(s) (PLD(s)), field programmable logic device(s) (FPLD(s)), discrete logic, hardware, firmware, etc. Also, some or all of the example session manager 420 may be implemented manually or as any combination of any of the foregoing techniques. For example, the session manager 420 may be implemented by any combination of firmware, software and/or hardware.

The example processor 425 of FIG. 4 is in communication with the main memory (e.g., the RAM 440 and/or the ROM 445) via a bus 450. The example RAM 440 may be implemented by DRAM, SDRAM, and/or any other type of RAM device. The example ROM 445 may be implemented by flash memory and/or any other desired type of memory device. Access to the memories 440 and 445 is typically controlled by a memory controller (not shown). The RAM 440 may be used, for example, to store one or more thresholds which are used to determine whether and/or when to perform background scanning.

The example circuit board 205 of FIG. 4 also includes any number and/or type(s) of interface circuits 455. The example interface circuit 455 of FIG. 4 may implement any number and/or type(s) of interfaces, such as external memory interface(s), serial port(s), general purpose input/output port(s), etc. Additionally or alternatively, the interface circuit 455 may communicatively couple the example wireless modem 410 and/or the network interface 415 with the processor 425 and/or the example session manager 420.

In the example of FIG. 4, any number and/or type(s) of input devices 460 and any number and/or type(s) of output devices 465 are connected to the interface circuit 455. To facilitate user inputs via a keypad (e.g., the example keypad 150 of FIGS. 1 and/or 3), the example circuit board 205 of FIG. 4 includes any type of keypad interface 470. The example keypad interface 470 of FIG. 4 electrically couples and/or translates electrical signals conveying key press information from the example keypad 145 to the example processor 425.

To provide output information to a user via a display (e.g., the example display 150 of FIGS. 1 and/or 3), the example circuit board 205 of FIG. 4 includes any number and/or type(s) of display interfaces 475. An example display interface 475 receives information (e.g., video, web page, email, text message, alphanumeric characters, etc.) to be displayed from the example processor 425 and creates electrical signals suitable for displaying the information on the example display 150.

To implement voice over IP (VoIP) services, the example circuit board 205 of FIG. 4 includes a VoIP processor 480. However, a circuit board 205 need not include a VoIP processor 480. The example VoIP processor 480 of FIG. 4 implements, among other things, session control, VoIP protocols, a SIP user agent, and a coder (not shown) to encode audio and/or video signals, a decoder (not shown) to decode received audio and/or video signals, a packetizer (not shown) to packetize encoded data and a de-packetizer (not shown) to de-packetize encoded data.

To electrically couple signals (e.g., speech signals) between a handset (e.g., the example handset 155 of FIGS. 1 and/or 3) and the example VoIP processor 480, the example circuit board 205 of FIG. 4 includes any number and/or type(s) of analog circuits 482. An example analog circuit 482 includes any number and/or type(s) of filter(s), analog-to-digital converter(s) and/or digital-to-analog converter(s) to convert between analog signals sent to and/or received from an example handset 155 and digital signals sent to and/or received from the example VoIP processor 480.

To this end, the example analog circuit 482 of FIG. 4 may implement any number and/or type(s) of wireless communication technologies to communicatively couple the example VoIP processor 480 with any type of cordless handset 155. Moreover, the example analog circuit 482 of FIG. 4 may, additionally or alternatively, implement any number and/or type(s) of subscriber line interface circuits (SLICs) that allow any number and/or type(s) of corded and/or cordless PSTN-based telephones (not shown) to be electrically coupled to the example VoIP processor 480 of FIG. 4. The latter example could be used, for instance, in implementations where the example circuit board 205 is located in and/or implements a VoIP analog telephone adapter (ATA) and/or a VoIP residential gateway.

To access data stored on user transportable device (e.g., a smartcard 120, or a magnetically stripped card 121), the example circuit board 205 of FIG. 4 includes any number and/or type(s) of security interfaces, one of which is illustrated in FIG. 4 with reference number 485. Using any number of circuit(s), logic and/or method(s), the example security interface 485 accesses data from and/or stores data on a swiped, inserted and/or nearby user transportable devices 120, 121. Example security interfaces 485 are implemented in accordance with a past, present and/or future standard and/or specification for contact and/or contactless smartcards, for RFID tags and/or for magnetic striped cards. Additionally or alternatively, the session manager 420 can obtain user identification, billing information, etc. from a user via, for example, the keypad 145 and/or a computing device communicatively coupled to the IMS terminal 100, 300.

To connect one or more portable devices (e.g., a USB device 492 or a Bluetooth device 497) to an IMS terminal 100, 300, the example circuit board 205 of FIG. 4 includes any number and/or type(s) of communication interfaces, two of which are illustrated in FIG. 4 with reference numerals 490 and 495. Example communication interfaces include, but are not limited to, any type and/or speed USB interface 490, any type and/or speed Bluetooth interface 495, any type of serial interface, any type of parallel interface, and/or any other type of wired and/or wireless communication interface. The example interfaces 490, 495 couple signals between the processor 425 and the devices 492, 497, thereby allowing a user of an IMS terminal 100, 300 to use such devices in connection with the IMS terminal 100, 300. For example, a Bluetooth enabled PDA 497 can be coupled to an IMS terminal 100, 300 to transfer data between the PDA 497 and an IMS service provider 110A, 110B.

While an example manner of implementing the example circuit board 205 of FIGS. 2A and 2B is illustrated in FIG. 4, a circuit board 205 may be implemented using any number and/or type(s) of other and/or additional element(s), processor(s), device(s), component(s), circuit(s), module(s), interface(s), etc. Further, the element(s), processor(s), device(s), component(s), circuit(s), module(s), element(s), interface(s), etc. illustrated in FIG. 4 may be combined, divided, re-arranged, eliminated and/or implemented in other ways. Additionally, the example interface 455, the example wireless modem 410, the example network interface 415, the example session manager 420, the example security interface 485, the example USB interface 490, the example Bluetooth interface 490, the example VoIP processor 480 and/or, more generally, the example circuit board 205 of FIG. 4 may be implemented as any combination of firmware, software, logic and/or hardware. Moreover, the example circuit board 205 may include additional processor(s), device(s), component(s), circuit(s), interface(s) and/or module(s) than those illustrated in FIG. 4 and/or may include more than one of any or all of the illustrated processor(s), device(s), component(s), circuit(s), interface(s) and/or module(s).

FIG. 5 illustrates an example data structure that may be used to store user identification data, billing information, IMS communication service and/or access network parameters (i.e., security parameters) on a user transportable device 120, 120, such as a smartcard, RFID device and/or magnetic striped card. Persons of ordinary skill in the art will readily appreciate that the example data structure of FIG. 5 is generally stored on a user transportable device 120, 121 in such a way to limit access by unauthorized persons. For example, the user transportable device 120, 121 may contain encryption and decryption circuits that require a valid username and password to be provided before access to data stored on the user transportable device 120, 121 is granted. To control access to data stored on a user transportable device 120, 121, the example data structure of FIG. 5 includes a user identification field 510 and a password field 515. The example user identification fields 510 and the example password field 515 contain one or more alphanumeric values that a user transportable device 120, 121 can use to authenticate the identity of a person attempting to access an IMS service using the user transportable device 120, 121.

The example data structure of FIG. 5 contains a plurality of entries 520 for respective ones of a plurality of access networks 105 and/or IMS service providers 110A, 110B. To identify an access network 105 and/or IMS service providers 110A, 110B, each of the entries 520 of FIG. 5 includes a service provider identification field 525. The example service provider identification field 525 of FIG. 5 contains one or more values and/or alphanumeric strings that uniquely identify an access network 105, an operator of access networks 105, an IMS network 110A, 110B and/or an operator of an IMS network 110A, 110B.

To specify authentication information for an access network 105 or an IMS service provider 110A, 110B (i.e., security parameters), each of the example entries 520 of FIG. 5 includes a user identification field 530 and an authentication credentials 535. The example user identification field 530 and the example authentication credential field 535 contain one or more alphanumeric values that an IMS terminal 100, 300 can use to gain access to an access network 105 and/or an IMS service provider 110A, 110B (i.e., security parameters). An example value that may be store in the credentials field 535 is an authentication value that an IMS terminal 100, 300 can use when register the IMS terminal 100, 300 to a session border controller and/or a proxy call session control function server of an IMS service provider 110A, 110B.

To specify one or more services available via an access network 105 and/or an IMS service provider 110A, 110B, each of the example entries 520 of FIG. 5 includes a services field 540. The example services field 540 of FIG. 5 includes one or more values and/or parameters that list, indicate and/or specify the type(s) and/or characteristics of services available via the access network 105 and/or the IMS service provider 110A, 110B. Example values include access rate information associated with an access network 105, a list of services accessible via a particular IMS service provider 110A, 110B, etc.

To specify billing information, the example data structure of FIG. 5 includes a billing information field 545. The example billing information field 545 of FIG. 5 includes one or more values, parameters, strings and/or alphanumeric characters that specify an account to which service charges associated with the use of an IMS terminal 100, 300 are to be billed. An account specified in the billing information field 545 need not be the same account to which charges associated with IMS services provided by an IMS service provider 110A, 110B. However, the same account may be used for both usage service charges and IMS services charges and/or fees. Example values that may be stored in the billing information field 545 include, but are not limited to, a credit card number, an expiration date, an account number, a PIN, an account name, a password, etc.

While an example data structure is illustrated in FIG. 5, the example data structure may be implemented using any number and/or type(s) of other and/or additional fields and/or data. Further, the fields and/or data illustrated in FIG. 5 may be combined, divided, re-arranged, eliminated and/or implemented in any of a variety of ways. Moreover, the example data structure may include additional fields and/or data than those illustrated in FIG. 5 and/or may include more than one of any or all of the illustrated fields and/or data.

FIG. 6 illustrates an example data structure that may be used to implement a message and/or query to obtain an IMS service provider identifier, such as an IP address. The example data structure of FIG. 6 is constructed in accordance with a VoIP protocol message, such as a SIP REGISTER message. However, any type of data structure may be used to user identification data and billing information to a redirect server 118.

To identify the SIP message, the example data structure of FIG. 6 includes a name field 605. The example name field 605 of FIG. 6 includes an alphanumeric string that identifies the SIP message and identifies a destination for the example message. The example SIP message illustrated in FIG. 6 is a SIP REGISTER message and, thus, the example name field 605 contains a string that includes “REGISTER SIP:”. Such a SIP message may be sent to, for example, provide a user identification (e.g., a telephone number) and billing information (e.g., a credit card number and expiration date). In the illustrated example data structure, the SIP message is addressed to redirect@att.com, where redirect@att.com is a SIP uniform resource identifier (URI) for the example redirect server 118. Persons of ordinary skill in the art will readily recognize that the name field 605 could be used to identify other types of SIP messages to other destinations.

To provide additional values and/or parameters, the example data structure of FIG. 6 includes one or more header fields 610. Example header fields 610 include, but are not limited to, a from field 515, a caller identification field, a command sequence number field, a billing-info field 520, and/or payload length field. The number of header fields 610, in some examples, depends upon the type of SIP message and/or the protocol(s) implemented by either endpoint. The example from field 515 of FIG. 5 includes a 10-digit telephone number that is associated with a particular IMS service provider 110A, 110B. The example billing-info field 520 of FIG. 5 includes one or more entries that specify an account to which service charges for use of an IMS terminal 100, 300 are to be billed. To convey and/or carry any number and/or type(s) of additional data and/or information, the example data structure of FIG. 6 may optionally include a payload 625.

While an example data structure is illustrated in FIG. 6, the example data structure may be implemented using any number and/or type(s) of other and/or additional fields and/or data. Further, the fields and/or data illustrated in FIG. 6 may be combined, divided, re-arranged, eliminated and/or implemented in any of a variety of ways. Moreover, the example data structure may include additional fields and/or data than those illustrated in FIG. 6 and/or may include more than one of any or all of the illustrated fields and/or data.

FIGS. 7A and 7B illustrate an example manner of implementing the example session manager 420 of FIG. 4. To select an access network 105, the example session manager 420 of FIG. 7A includes an access provider selector 705. The example access provider 705 of FIG. 7A selects an access network 105 by determining which, if any, access networks 105 are currently available to an IMS terminal 100, 300 that implements the session manager 420. Based upon a determined list of available access networks 105, the example access provider selector 705 selects a particular access network 105 by comparing the list to a list of access networks 105 stored on a user transportable device 120, 121 swiped, nearby and/or inserted in the IMS terminal 100, 300. Additionally or alternatively, the access provider selector 705 can provide the list of available access networks 105 and any associated access charges associated with the available access networks 105 such that a user of the IMS terminal 100, 300 can select an access network 105. The example access provider selector 705 could alternatively automatically select an access network 105 based upon one or more preferences associated with the list of access networks 105 stored on the user transportable device 120, 121. For example, the user transportable device 120, 121 could prioritize the list of access networks 105 such that the highest priority available access network 105 is automatically used.

To monitor communication with a connected access network 105, the example session manager 420 of FIG. 7A includes a connectivity monitor 710. The example connectivity monitor 710 of FIG. 7A determines when a connection to a particular access network 105 is no longer available and/or may become unavailable, and notifies the access provider selector 705 such that a different access network 105 can, if possible, be selected. The connectivity monitor 710 can monitor connections by, for example, monitoring the signal strength and/or quality associated with the connection. Additionally or alternatively, the example connectivity monitor 710 can track and/or record usage of an IMS terminal 100, 300. For example, the connectivity monitor 710 store CDRs for services access via the IMS terminal 100, 300 and then report such CDRs to a billing server. A CDR may be sent, for example, after each telephone call is completed and/or may be collected and sent when the user relinquishes control of the IMS terminal 100, 300.

To negotiate communication sessions with IMS service providers 110A, 110B, the example session manager 420 of FIG. 7A includes a session negotiator 715. The example session negotiator 715 can perform, for example, registration of an IMS terminal 100, 300 that implements the session negotiator 715 using session initiation protocol (SIP) messages and/or exchanges. For example, the session negotiator 715 can perform a SIP registration to register the IMS terminal 100, 300 with an IMS service provider 110A, 110B and use a SIP INVITE message to establish a communication session for a particular IMS service. An example manner of implementing the example session negotiator 715 is described below in connection with FIG. 7B.

The example session negotiator 715 of FIG. 7A determines an IMS provider 110A, 110B for a user based upon user identification data provided by the user and/or based upon which IMS providers 110A, 110B are currently available to an IMS terminal 100, 300 that implements the session negotiator 715. In one example, the session negotiator 715 sends a SIP registration message (e.g., the example message of FIG. 6) to a redirect server (e.g., the example redirect server 118) and receives an identifier of an IMS service provider 110A, 110B associated with the user identification data. In another example, the session negotiator 715 performs an ENUM lookup based upon the user identification data to obtain the IMS service provider identifier. Additionally or alternatively, the session negotiator 715 can select an IMS service provider 110A, 110B by comparing a list of available IMS service providers 110A, 110B with a list of IMS service providers 110A, 110B stored on a user transportable device 120, 121. Additionally or alternatively, the session negotiator 715 can present a list containing the IMS service provider 110A, 110B obtained based on the user identification as well as any other available IMS service providers 110A, 110B, and any associated access charges associated with the available IMS service providers 110A, 110B such that a user of the IMS terminal 100, 300 can select a particular IMS service provider 110A, 110B. The example session negotiator 715 could alternatively automatically select an IMS service provider 110A, 110B based upon one or more preferences associated with the list of access networks 105 stored on the user transportable device 120, 121 and/or a selected IMS service to be accessed. For example, the user transportable device 120, 121 could prioritize the list of IMS service provider 110A, 110B such that the highest priority available IMS service provider 110A, 110B is automatically used. In some example, the session negotiator 715 first attempts to initiate a communication session with a user's home IMS service provider 110A, 110B before attempt to initiate a communication session with an alternative IMS service provider 110A, 110B.

FIG. 7B illustrates an example manner of implementing the example session negotiator 715 of FIG. 7A. To create a secure communication path between the example session negotiator 715 of FIG. 7B and the redirect server 118, the session negotiator 715 includes any type of encrypted VPN module 720.

To collect billing information, the example session negotiator 715 of FIG. 7B includes a billing collector 725. The example billing collector 725 of FIG. 7B collects billing information from one or more swiped, inserted and/or nearby transportable user devices 120, 121 and/or as entered by a user via, for example, the example keypad 145.

To collect user identification data, the example session negotiator 715 of FIG. 7B includes a credentials collector 730. The example credentials collector 730 of FIG. 7B collects user identification data from one or more swiped, inserted and/or nearby transportable user devices 120, 121 and/or as entered by a user via, for example, the example keypad 145.

To register the IMS terminal 100, 300 that implements the example session manager 715 of FIG. 7B, the session manager 715 includes a SIP user agent 735. The example SIP user agent 735 of FIG. 7B sends a first SIP registration message via the encrypted VPN module 720 to the redirect server 118. The first SIP registration message includes user identification data collected by the example credentials collector 730 and billing information collected by the payment collector 725. In response to the first SIP registration message, the SIP user agent 735 receives an identifier for an IMS service provider 110A (e.g., an IP address), 110B associated with the user identification data. The example SIP user agent 735 of FIG. 7B sends a second SIP registration message to the IMS service provider using the received IP address.

Alternatively, to obtain an IMS service provider identifier (e.g., an IP address), the example session negotiator 715 includes an ENUM lookup agent 740. The example ENUM lookup agent 740 of FIG. 7B performs an ENUM lookup on the redirect server 118 based upon the user identification data collected by the example credentials collector 730. The example ENUM lookup agent 740 performs the ENUM lookup via the encrypted VPN module 720. If the ENUM lookup agent 740 is used to obtain the IMS service provider identifier, the SIP user agent 735 can skip sending the first SIP registration message.

While an example manner of implementing the example session manager 420 of FIG. 4 is illustrated in FIGS. 7A and 7B, the session manager 420 may be implemented using any number and/or type(s) of other and/or additional element(s), processor(s), device(s), component(s), circuit(s), module(s), interface(s), etc. Further, the element(s), processor(s), device(s), component(s), circuit(s), module(s), element(s), interface(s), etc. illustrated in FIGS. 7A and/or 7B may be combined, divided, re-arranged, eliminated and/or implemented in other ways. Additionally, the example access provider selector 705, the example connectivity monitor 710, the example session negotiator 715, the example encrypted VPN module 720, the example payment collector 725, the example credentials collector 730, the example SIP user agent 735, the example ENUM lookup agent 740 and/or, more generally, the example session manager 420 of FIG. 7A may be implemented as any combination of firmware, software, logic and/or hardware. Moreover, the example session manager 420 may include additional processor(s), device(s), component(s), circuit(s), interface(s) and/or module(s) than those illustrated in FIGS. 7A and/or 7B and/or may include more than one of any or all of the illustrated processor(s), device(s), component(s), circuit(s), interface(s) and/or module(s).

FIG. 8 illustrates an example manner of implementing any or all of the example IMS service provider networks 110A, 110B of FIG. 1. While any of the example IMS service provider networks 110A, 110B of FIG. 1 can be represented by FIG. 8, for ease of discussion, the example network of FIG. 8 will be referred to as IMS service provider network 110A. To communicatively couple the IMS terminal 100, 300 to the IMS service provider network 110A, the example IMS service provider 110A of FIG. 8 includes any number and/or type(s) of edge devices, one of which are illustrated in FIG. 8 with reference numeral 802. An example edge device 802 is any type of session border controller implemented in accordance with any past, present and/or future IMS standard and/or specification.

In the illustrated example system of FIG. 8, each active IMS terminal 100, 300 is registered to, associated with and/or assigned to a serving call session control function (S-CSCF) server 805 responsible for handling incoming and/or outgoing calls associated with its registered IMS terminals 100, 300. That is, an S-CSCF 805 performs sessions control, maintains session state and/or enables communication with application servers for its associated and/or registered IMS terminals 100, 300. For instance, for a IMS terminal 100, 300 initiating a communication session, a SIP INVITE message is routed by the IMS service provider 110A to its associated S-CSCF 805 which, in turn, routes and/or assists in establishing a communication path and/or communication session (e.g., a telephone call) with a called device (i.e., a called party). Likewise, an IMS terminal 100, 300 receiving an incoming communication session receives a SIP INVITE message via its associated S-CSCF 805.

To provide an initial interface between an IMS terminal 100, 300 and the S-CSCF 805 to which it is registered and/or to be registered, the example IMS service provider 110A of FIG. 8 includes any number and/or type(s) of proxy call session control function (P-CSCF) servers 810. The example P-CSCF 805 of FIG. 8, among other things, routes SIP messages between an IMS terminal 100, 300 and its S-CSCF 805.

To locate the S-CSC 805 associated with an IMS terminal 100, 300, the example IMS service provider 110A of FIG. 8 includes any number and/or type(s) of interrogating call session control function (I-CSCF) server 815. The example I-CSCF 815 of FIG. 8 serves as a contact point within the example IMS service provider 110A for all connections destined for an IMS terminal 100, 300 and/or for an IMS terminal 100, 300 currently located within the serving area of the IMS service provider 110A (e.g., a roaming subscriber). For example, for an incoming communication session (e.g., a telephone call), the example I-CSCF 815 identifies which S-CSCF 805 to which the destination IMS terminal 100, 300 is registered. Based upon the S-CSCF 805 identified by the I-CSCF 815, the P-CSCF 810 routes a SIP protocol message between the IMS terminal 100, 300 and the S-CSCF 805.

To manage subscriber information and/or to enable subscribers and/or servers to locate destinations, the example IMS service provider 110A of FIG. 8 includes any number and/or type(s) of home subscriber servers (HSSs) 825. The example HSS 825 of FIG. 8 maintains a profile and/or one or more preferences for each subscriber of the IMS service provider 110A. The example I-CSCF 815 of FIG. 8 uses information contained in the HSS 825 to determine and/or locate the S-CSCF 805 associated with a subscriber and/or an IMS terminal 100, 300.

To process and/or handle communication service data between any of the example IMS terminals 100, 300 and a PLMN 830 (e.g., a cellular communication network) and/or a PSTN 835, the example IMS service provider 110A of FIG. 8 includes any number and/or type(s) of media gateways 840. Using any number and/or type(s) of technique(s), method(s) and/or algorithm(s), the media gateway 840 of FIG. 8 performs any necessary data conversion between, for example, a circuit-based transmission format used by the PSTN 835 and a packet-based format and/or data structure used by the IMS service provider 110A, the IP network 115, and/or the IMS terminals 100, 300.

To control the example media gateway 845, the example IMS service provider 110A of FIG. 8 includes any number and/or type(s) of media gateway controllers (MGCs) 845. Using any number and/or type(s) of technique(s), method(s) and/or in accordance with any past, present and/or future specification(s) and/or standard(s) such as, for example, Internet Engineering Task Force (IETF) Request for Comment (RFC) 3015 and/or the ITU-T H.248 standard, the example MGC 845 of FIG. 8 performs signaling, session control and/or session management for incoming and/or outgoing IMS communication sessions that originate in and/or terminate in, for example, the example PLMN 830 and/or the PSTN 835.

As illustrated in FIG. 8, the example IMS service provider 110A may include an interface to and/or contain a portion of the PLMN 830, an interface to and/or contain a portion of the PSTN 135, and/or an interface to and/or contain a portion of any number and/or type(s) of additional communication networks. For example, using any number and/or type(s) of technique(s), method(s), protocol(s) and/or technology(-ies), the media gateway 840, the MGC 845 and the PSTN 835 can facilitate telephone calls between a PSTN-based phone (not shown) and any of the example IMS terminals 100, 300

The example PLMN 830 and/or the example PSTN 835 of FIG. 8 may be implemented by any number and/or type(s) of communication devices, switches, protocols, systems and/or technologies. For instance, the example PLMN 830 may include any number of cellular base stations that can transmit cellular signals to and/or receive cellular signals from a cellular communication device (not shown) using any type(s) of protocols (e.g., time-division multiple access (TDMA), code-division multiple access (CDMA), orthogonal frequency-division multiple access (OFDM), etc.). In some examples, an interface between the MGC 840 and the PLMN 830 is implemented via the PSTN 835.

It will be readily appreciated by persons of ordinary skill in the art that the example session border controller 802, the example the example S-CSCF 805, the example P-CSCF 810, the example I-CSCF 815, the example HSS 825, the example media gateway 840 and the example MGC 845 illustrated in FIG. 8 are logical entities in IP multimedia sub-system (IMS) based networks, such as the example IMS service provider networks 110A, 110B of FIG. 1. They may be implemented, for example, as machine accessible instructions executed by one or more computing devices and/or computing platforms (e.g., the example processor platform 1300 discussed below in connection with FIG. 13). Further, while an example IMS service provider network 110A has been illustrated in FIG. 8, the example logical entities of the IMS service provider 110A may be combined, split, re-arranged, eliminated and/or implemented in any of a variety of ways. Further still, the example S-CSCF 805, the example P-CSCF 810, the example I-CSCF 815, the example HSS 825, the example media gateway 840, the example MGC 845 and/or, more generally, the example IMS service provider 110A may be implemented by hardware, software, firmware and/or any combination of hardware, software and/or firmware. Moreover, call serving office may include additional logical entities and/or may include more than one of any of the illustrated logical entities.

FIG. 9 illustrates an example manner of implementing the example redirect server 118 of FIG. 1. To communicatively couple the example redirect server 118 of FIG. 9 to another device and/or network (e.g., any or all of the example IMS terminals 100, 300), the example redirect server 118 includes any number and/or type(s) of network interfaces 902. The example network interface 902 of FIG. 9 operates in accordance with any of the IEEE 802.3x (a.k.a. Ethernet) family of standards.

To create a secure communication path between the example redirect server 118 of FIG. 9 and an IMS terminal 100, 300 via the network interface 902, the example redirect server 118 includes any type of encrypted VPN module 905.

To store associations of user identifications (e.g., telephone numbers) to IMS service providers 110A, 110B, the example redirect server 118 of FIG. 9 includes a telephone number (TN) to provider database 910. The example TN to provider database 910 comprises a listing of associated telephone numbers and IMS service provider identifiers (e.g., IP addresses). Based upon a telephone number, the TN to provider database 910 can be searched to obtain the associated IMS service provider identifier. The example TN to provider database 910 is stored using any number and/or type(s) of memory(-ies) and/or storage device(s) 915.

To process received SIP messages, the example redirect server 118 of FIG. 9 includes a SIP agent 920. When a SIP registration message (e.g., the example message of FIG. 6) is received via the example encrypted VPN module 905 and the example network interface 902, the example SIP agent 920 of FIG. 9 queries the TN to provider database 910 to obtain the IMS service provider identifier associated with the telephone number contained in the SIP registration message. The SIP agent 920 sends the IMS service provider identifier to the IMS terminal 100, 300 that sent the SIP registration message.

To verify billing information received in a SIP registration message or via an ENUM query, the example redirect server 118 of FIG. 9 includes a billing agent 925. The example billing agent 925 of FIG. 9 processes received billing information to verify that the user attempting to use the billing information to pay for service charges associated with gaining access to and/or using an IMS terminal 100, 300. Once use of an IMS terminal 100, 300 is completed, the billing agent 925 finalizing the usage service charges and bills the charges to the identified account. The example SIP agent 920 of FIG. 9 does not send the IMS service provider identifier to the IMS terminal 100, 300 until the billing information received in the SIP registration message has been verified by the billing agent 925. Additionally or alternatively, the example billing agent 925 receives and/or processing usage records received from IMS terminals 100, 300. For example, the IMS terminals 100, 300 could collect CDRs that represent call made by users of the IMS terminal 100, 300. Such usage records allow the provider, owner and/or operator of the IMS terminal 100, 300 to bill for overall usage of the IMS terminal 100, 300 and/or based upon actual usage durations and/or call destinations. They may also be used for reconciliation of billing records between users and service providers.

To allow an IMS terminal 100, 300 perform an ENUM lookup, the example redirect server 118 of FIG. 9 includes an ENUM server 930. Using any method(s), algorithm(s) and/or logic, the example ENUM server 930 performs ENUM queries of the TN to provider database 910 when a query to do so is received from the IMS terminal 100, 300 via the encrypted VPN module 905 and the network interface 902. Upon completing of the ENUM query, the example ENUM server 930 returns the IMS service provider identifier to the IMS terminal 100, 300. In the example of FIG. 9, the ENUM lookup request received from an IMS terminal 100, 300 includes billing information that the example billing agent 925 verifies before the ENUM server 930 returns the IMS service provider identifier to the IMS terminal 100, 300

While an example manner of implementing the example redirect server 118 of FIG. 1 is illustrated in FIG. 9, the redirect server 118 may be implemented using any number and/or type(s) of other and/or additional element(s), processor(s), device(s), component(s), circuit(s), module(s), interface(s), etc. Further, the element(s), processor(s), device(s), component(s), circuit(s), module(s), element(s), interface(s), etc. illustrated in FIG. 9 may be combined, divided, re-arranged, eliminated and/or implemented in other ways. Additionally, the example network interface 902, the example encrypted VPN module 905, the example TN to provider database 910, the example SIP agent 920, the example billing agent 925, the example ENUM server 930 and/or, more generally, the example redirect server 118 of FIG. 9 may be implemented as any combination of firmware, software, logic and/or hardware. Moreover, the example session manager 420 may include additional processor(s), device(s), component(s), circuit(s), interface(s) and/or module(s) than those illustrated in FIG. 9 and/or may include more than one of any or all of the illustrated processor(s), device(s), component(s), circuit(s), interface(s) and/or module(s).

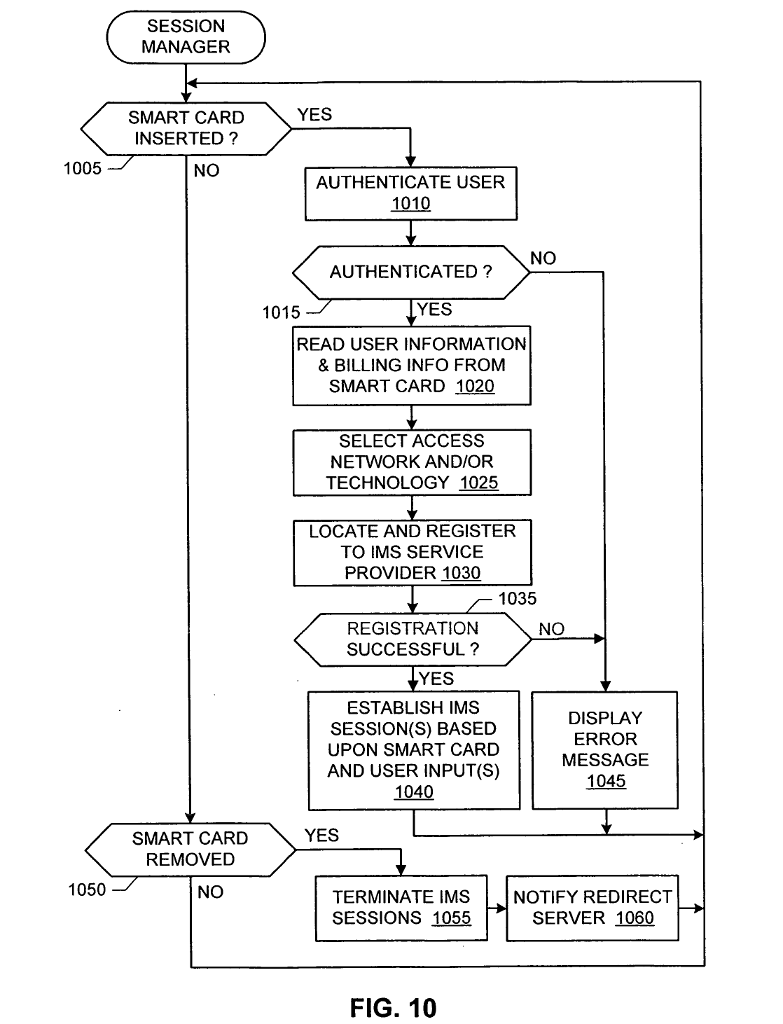

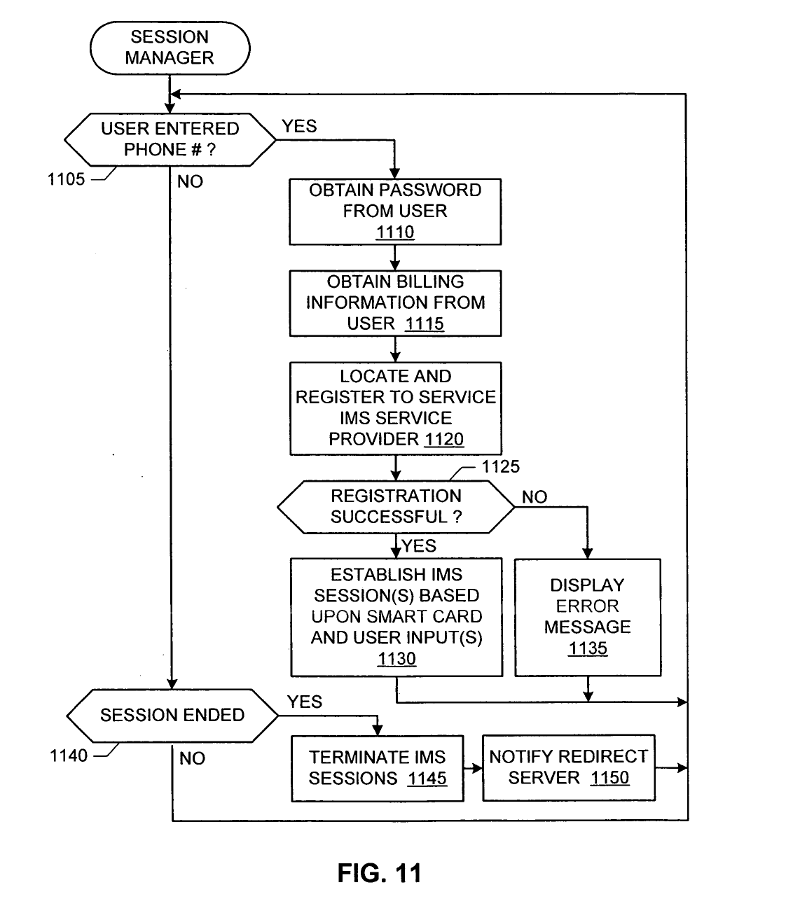

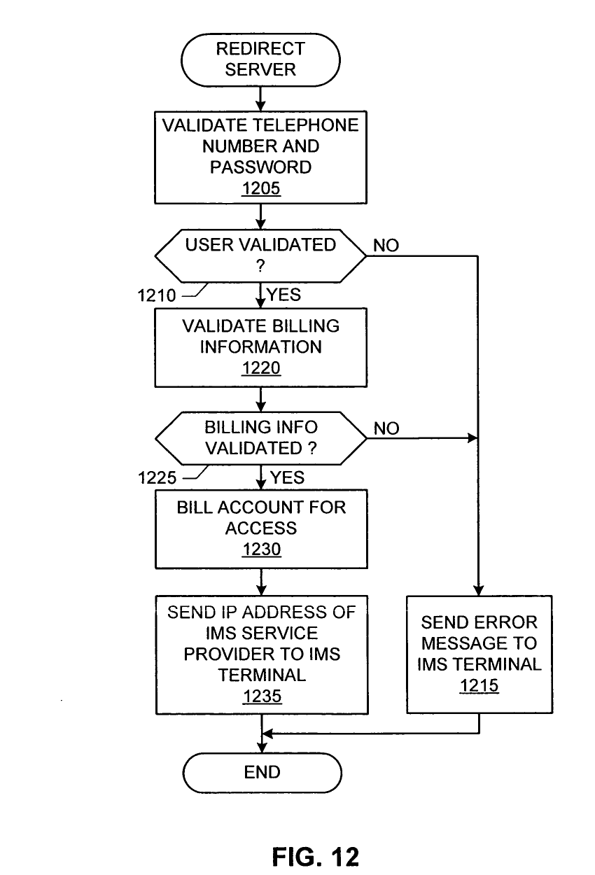

FIGS. 10 and 11 are flowcharts representative of example processes that may be carried out to implement any of the example session managers 420 and/or, more generally, any of the example IMS terminals 100, 300 of FIGS. 1, 3, 4, 7A and 7B. FIG. 12 is a flowchart representative of an example process that may be carried out to implement any of the example redirect servers 118 of FIGS. 1 and 9. The example processes of FIGS. 10, 11 and 12 may be carried out by a processor, a controller and/or any other suitable processing device. For example, some or all of example processes of FIGS. 10, 11 and/or 12 may be embodied in coded instructions stored on a tangible medium such as a flash memory, a ROM and/or RAM associated with a processor (e.g., the example processor 425 of FIG. 4 and/or the example processor 1305 of FIG. 13). Alternatively, some or all of the example process of FIGS. 10, 11 and/or 12 may be implemented using any combination(s) of ASIC(s), PLD(s), FPLD(s), discrete logic, hardware, firmware, etc. Also, some or all of the example process of FIGS. 10, 11 and/or 12 may be implemented manually or as any combination(s) of any of the foregoing techniques, for example, any combination of firmware, software, discrete logic and/or hardware. Further, although the example processes of FIGS. 10, 11 and 12 are described with reference to the flowcharts of FIGS. 10, 11 and 12, persons of ordinary skill in the art will readily appreciate that many other methods of implementing the example session managers 420, the example IMS terminals 100, 300, the example redirect servers 118 described herein may be employed. For example, the order of execution of the blocks may be changed, and/or some of the blocks described may be changed, eliminated, sub-divided, or combined. Additionally, persons of ordinary skill in the art will appreciate that the example processes of FIGS. 10, 11 and/or 12 may be carried out sequentially and/or carried out in parallel by, for example, separate processing threads, processors, devices, discrete logic, circuits, etc.

The example process of FIG. 10 begins with a session manager (e.g., the example session manager 420 of FIGS. 4 and/or 7A) determining if a user transportable device (e.g., a smartcard 120, a stripped card 121, etc.) has been swiped, inserted in an IMS terminal 100, 300 and/or is nearby (block 1005). If a smartcard has been inserted (block 1005), the session manager authenticates the user who inserted the smartcard (block 1010). For example, the session manager prompts the user to enter a username and password and then provides the same to the smartcard.

If the user is not successfully authenticated (block 1015), control proceeds to block 1045 to display any type of error message. Alternatively, control can return to block 1010 to re-prompt the user and re-attempt to authenticate the user.

If the user is successfully authenticated (block 1015), user identification data and billing information is accessed and/or read from the inserted smartcard (block 1020). The session manager (e.g., the example access network selector 705 of FIG. 7A) selects an access network 105 and/or access network technology based upon access network information stored on the inserted smartcard, one or more user inputs, and based upon available access network 105, and connects to the selected access network 105 (block 1025).

Once an access network 105 has been selected and connected to (block 1025), the session manager (e.g., the example session negotiator 715 of FIGS. 7A and/or 7B) locates, selects and attempts to register the IMS terminal 100, 300 to the selected IMS service provider 110A, 110B (block 1030). For example, the session manager sends a SIP registration message to a redirect server (e.g., the example redirect server 118 of FIG. 1) to obtain an identifier for the IMS service provider. Alternatively, the session manager performs an ENUM lookup on the redirect server based on the user identification data to obtain the IMS service provider identifier.

If the registration is successful (block 1035), the session negotiator initiates one or more communications for respective ones of one or more IMS services selected by the user (block 1040). Control then returns to block 1005. If the registration is not successful (block 1035), control proceeds to block 1045 to display any type of error message (block 1045). Control then returns to block 1005.

Returning to block 1005, if a user transportable device (e.g., a smartcard) was not inserted (block 1005), the session manager detects if a smartcard was removed from the IMS terminal 100, 300 (block 1050). If a smartcard was removed (block 1050), the session manager terminates any current IMS communication sessions and de-registers the IMS terminal 100, 300 with all IMS service providers 100, 300 to which it is currently registered (block 1055). The session manager notifies the redirect server that usage of the IMS terminal has ceased and sends any collected usage records to the redirect server and/or a billing server (block 1060). Additionally or alternatively, the IMS terminal 100, 300 sends the usage records after each IMS session (e.g., a telephone call) is completed. Control then returns to block 1005 to check for the insertion of a smartcard. If a smartcard was not removed (block 1050), control returns to block 1005.

FIG. 11 illustrates an alternative process that may be used to implement the example session managers 420 and/or, more generally, the example IMS terminals 100, 300 described herein. Persons of ordinary skill in the art will readily appreciate that a session manager 420 and/or an IMS terminal 100, 300 could implement both of the example processes of FIGS. 10 and 11, and/or any combination thereof.

The example process of FIG. 11 begins with a session manager (e.g., the example session manager 420 of FIGS. 4 and/or 7) determining if a user has entered user identification information, such as a telephone number (block 1105). If a telephone number has been inserted (block 1105), the session manager obtains a password that can be used to verify that the user is authorized to access IMS services associated with the entered telephone number (block 1110). The session manager also obtains billing information from the user (block 1115). For example, the session manager prompts the user to swipe a credit card and/or a calling card, and/or to enter a credit card number and/or a calling card number.

The session manager (e.g., the example session negotiator 715 of FIG. 7) locates, selects and attempts to register the IMS terminal 100, 300 to the selected IMS service provider 110A, 110B (block 1120). For example, the session manager sends a SIP registration message to a redirect server (e.g., the example redirect server 118 of FIG. 1) to obtain an identifier for the IMS service provider. Alternatively, the session manager performs an ENUM lookup on the redirect server based on the user identification data to obtain the IMS service provider identifier.

If the registration is successful (block 1125), the session negotiator initiates one or more communications for respective ones of one or more IMS services selected by the user (block 1130). Control then returns to block 1105. If the registration is not successful (block 1125), control proceeds to block 1135 to display any type of error message (block 1135). Control then returns to block 1105.

Returning to block 1105, if a user did not enter a telephone number (block 1105), the session manager detects the user has indicate they are no longer going to use the IMS terminal (block 1140). If the IMS terminal is not longer going to be used (block 1140), the session manager terminates any current IMS communication sessions and de-registers the IMS terminal 100, 300 with all IMS service providers 100, 300 to which it is currently registered (block 1145). The session manager notifies the redirect server that usage of the IMS terminal has ceased and sends any collected usage records to the redirect server and/or a billing server (block 1150). Additionally or alternatively, the IMS terminal 100, 300 sends the usage records after each IMS session (e.g., a telephone call) is completed. Control then returns to block 1105 to check for the entering of a telephone number. If use of the IMS terminal 100, 300 was not ended (block 1140), control returns to block 1105.

The example process of FIG. 12 begins when a redirect server (e.g., any of the example redirect servers 118 of FIGS. 1 and 9) receives a SIP registration message or an ENUM lookup request from an IMS terminal 100, 300. The redirect server (e.g., the example SIP agent 920 or the ENUM server 930) verifies that the user is authorized to access IMS services associated with user identification data received in the SIP registration message or ENUM lookup request (block 1205). For example, the redirect server verifies that a received password matches that associated with a received telephone number.

If the user is not authorized to access IMS services (block 1210), the redirect server sends an error message to the IMS terminal 100, 300 (block 1215). Control then exits from the example process of FIG. 12. If the user is authorized to access IMS services (block 1210), the redirect server (e.g., the example billing agent 925 of FIG. 9) validates the billing information received in the SIP registration message or the ENUM lookup request (block 1220).

If the billing information is not verifiable (block 1225), the redirect server sends an error message to the IMS terminal 100, 300 (block 1215). Control then exits from the example process of FIG. 12. If the billing information is verifiable (block 1225), the billing agent bills the account specified by the billing information for use of the IMS terminal 100, 300 (block 1230). Alternatively, the billing agent at block 1230 starts metering use of the IMS terminal so that service charges associated with use of the IMS terminal 100, 300 can accrue.

The redirect server looks up the identifier of an IMS service provider (e.g., an IP address) based upon the telephone number received in the SIP registration message or the ENUM lookup request, and sends the IP address to the IMS terminal 100, 300 (block 1235). Control then exits from the example process of FIG. 12.

FIG. 13 is a schematic diagram of an example processor platform 1300 that may be used and/or programmed to implement all or a portion of the example session manger 420 and/or the example redirect servers 118 described herein. For example, the processor platform 1300 can be implemented by one or more general purpose processors, processor cores, microcontrollers, etc.

The processor platform 1300 of the example of FIG. 13 includes at least one general purpose programmable processor 1305. The processor 1305 executes coded instructions 1310 and/or 1312 present in main memory of the processor 1305 (e.g., within a RAM 1315 and/or a ROM 1320). The processor 1305 may be any type of processing unit, such as a processor core, a processor and/or a microcontroller. The processor 1305 may execute, among other things, the example processes of FIGS. 10, 11 and/or 12. The processor 1305 is in communication with the main memory (including a ROM 1320 and/or the RAM 1315) via a bus 1325. The RAM 1315 may be implemented by DRAM, SDRAM, and/or any other type of RAM device, and ROM may be implemented by flash memory and/or any other desired type of memory device. Access to the memory 1315 and 1320 maybe controlled by a memory controller (not shown). The RAM 1315 may be used to store and/or implement, for example, the example TN to provider database 910 of FIG. 9.

The processor platform 1300 also includes an interface circuit 1330. The interface circuit 1330 may be implemented by any type of interface standard, such as an external memory interface, serial port, general purpose input/output, etc. One or more input devices 1335 and one or more output devices 1340 are connected to the interface circuit 1330. The input devices 1335 and/or output devices 1340 may be used to, for example, the network interface 902 of FIG. 9.

Persons of ordinary skill in the art will recognize that the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware and/or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a computer processor. However, hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. Such devices are periodically superseded by faster or more efficient systems having the same general purpose. Additionally, such standards and/or protocols are replaced with newer and/or more advanced standards having a similar purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. An apparatus comprising:
a first interface configured to receive a user identification from a user;
a second interface configured to receive billing information from the user; and
a session manager to identify an Internet multimedia sub-system (IMS) service provider based on the received user identification, wherein a fee to access the IMS service provider is charged based upon the billing information.

2. An apparatus as defined in claim 1, wherein the first interface reads the user identification from a user transportable device.

3. (canceled)

4. An apparatus as defined in claim 1, wherein the first interface and the second interface are a same interface.

5. An apparatus as defined in claim 1, further comprising:
a keypad to implement the first interface; and
a magnetic card reader to implement the second interface.

6. (canceled)

7. An apparatus as defined in claim 1, wherein the user identification is a telephone number, the telephone number associated with a particular IMS service provider.

8. An apparatus as defined in claim 1, wherein the first interface implements at least one of a contact smartcard reader, a contactless smartcard reader, a radio frequency identification (RFID) reader or a magnetic stripe reader.

9. An apparatus as defined in claim 1, further comprising:
a first network interface configured to communicatively couple the processor to a first access network; and
a second network interface configured to communicatively couple the processor to a second access network, wherein the processor is configured to select between the first and the second network interfaces.

10. (canceled)

11. An apparatus as defined in claim 1, wherein the session manager comprises:
a network interface to communicatively couple the session manager to a electronic numbering (ENUM) server;
an ENUM lookup agent to perform an ENUM query of the ENUM server to obtain an Internet Protocol (IP) address for the IMS service provider based upon the user identification.

12. An apparatus as defined in claim 11, further comprising:
an encrypted virtual private network (VPN) module;
a payment collector to obtain the billing information via the second interface; and
a credentials collector to obtain the user identification via the first interface.

13. (canceled)

14. An apparatus as defined in claim 11, further comprising a payment collector to collect a call detail record and to send the call detail record to a billing server.

15. An apparatus as defined in claim 1, wherein the session manager comprises:
a network interface to communicatively couple the session manager to a redirect server;
a session initiation protocol (SIP) agent to send a SIP registration message to the redirect server and to receive an Internet Protocol (IP) address for the IMS service provider from the redirect server, the SIP registration message comprising the user identification and the billing information.

16. An apparatus as defined in claim 15, wherein the session manager is to register to the IMS service provider using the received IP address.

17. (canceled)

18. An apparatus as defined in claim 1, wherein the apparatus is at least one of an IMS terminal, a voice over Internet protocol (VoIP) phone, a VoIP analog terminal adapter, a computer, a cell phone, a personal digital assistant, a smart phone or a kiosk.

19-29. (canceled)

30. An article of manufacture storing machine readable instructions which, when executed; cause a machine to:
receive a user identification from a user at an Internet multimedia sub-system (IMS) terminal;
receive billing information from the user at the IMS terminal;
provide the user identification and the billing information to a redirect server to obtain an Internet Protocol (IP) address for an IMS service provider; and
register the IMS terminal to the IMS service provider based upon the obtained IP address.

31. An article of manufacture as defined in claim 30, wherein the user identification comprises a telephone number that is associated with the IMS service provider.

32. An article of manufacture as defined in claim 30, wherein the machine readable instructions, when executed, cause the machine to provide the user identification and the billing information to a redirect server to obtain an Internet Protocol (IP) address for an IMS service provider by performing an electronic numbering (ENUM) lookup based upon the user identification.

33. An article of manufacture as defined in claim 30, wherein the machine readable instructions, when executed, cause the machine to provide the user identification and the billing information to a redirect server to obtain an Internet Protocol (IP) address for an IMS service provider by:
sending a SIP registration message that includes the user identification and billing information to the redirect server; and
receiving the IP address in a response message.

34. An article of manufacture as defined in claim 30, wherein the machine readable instructions, when executed, cause the machine to receive the user identification from at least one of a keypad, a contact smartcard reader, a contactless smartcard reader, a radio frequency identification (RFID) reader or a magnetic stripe reader.

35. An article of manufacture as defined in claim 30, wherein the machine readable instructions, when executed, cause the machine to receive the billing information from at least one of a keypad, a contact smartcard reader, a contactless smartcard reader, a radio frequency identification (RFID) reader or a magnetic stripe reader.

36-43. (canceled)

44. A method of using an Internet multimedia sub-system (IMS) terminal, the method comprising:
providing a user identification to the IMS terminal;
providing billing information to the IMS terminal; and
accessing an IMS service via the IMS terminal, the IMS service established based upon the provided user identification, and usage of the IMS terminal is billed based upon the provided billing information.

45. A method as defined in claim 44, wherein providing the user identification to the IMS terminal comprises entering the user identification on a keypad of the IMS terminal.

46. A method as defined in claim 44, wherein providing the user identification to the IMS terminal comprises inserting a user transportable device into an externally accessible slot of the IMS terminal.

47. A method as defined in claim 44, wherein providing the billing information to the IMS terminal comprises entering the billing information on a keypad of the IMS terminal.

48. A method as defined in claim 44, wherein providing the billing information to the IMS terminal comprises swiping a magnetically striped card.

49. A method as defined in claim 44, wherein usage of the IMS terminal is billed separately from any charges associated with access the IMS service.

50. A method as defined in claim 44, authorizing charges for use of the IMS terminal to be billed based upon the provided billing information.

51. A method as defined in claim 44, further comprising:
renting the phone; and
relinquishing the phone.

52. A method as defined in claim 51, wherein renting the phone comprises initiating the entry of the user identification or the billing information.

53. A method as defined in claim 51, wherein relinquishing the phone comprises terminating the IMS service and finalizing the charges for the use of the IMS terminal.

54. A method as defined in claim 44, wherein the IMS terminal is publicly accessible.

55-72. (canceled)
